(19) United States
(12) Patent Application Publication
(10) Pub. No.: US 2008/0115166 A1
(43) Pub. Date: May 15, 2008

(54) DIGITAL VIDEO RECORDER PROCESSING SYSTEM

(76) Inventors: Kulvir Singh Bhogal, Fort Worth, TX (US); Gregory Jensen Boss, American Fork, UT (US); Rick Allen Hamilton, Charlottesville, VA (US); Alexandre Polozoff, Bloomington, IL (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/553,001

(22) Filed: Oct. 26, 2006

(51) Int. Cl. H04N 5/445; H04N 7/16; G06F 13/00; H04H 9/00

(52) U.S. Cl. 725/46; 725/13; 725/58

(57) ABSTRACT

A method and system are provided in which DVR viewer metrics are collected and saved in a “Watched Log” database including identifying titles and other features of recorded DVR programs. User viewing metrics on both “per user” and “per show” bases are saved and used to augment existing conflict resolution techniques by removing shows that have been entirely or partially viewed in favor of shows that have not already been viewed. After a DVR user watches a TV show episode, the TV show episode will be added to the Watched Log. Subsequently, before recording a future TV show, the DVR device can verify that the scheduled TV show episode has not already been watched by the user. If the show is in the Watched Log, various rules are used to determine which recording actions to take.

### RELATED APPLICATIONS

Subject matter disclosed but not claimed herein is disclosed and claimed in co-pending application 06-0649, which is included herein by reference.

### FIELD OF THE INVENTION

The present invention relates generally to recording systems and more particularly to a system and methodology for tracking viewer metrics for use in digital video recorder systems.

### BACKGROUND OF THE INVENTION

Currently available digital video recorder (DVR) devices allow a user to record television broadcasts to a hard drive-based digital storage medium. DVR devices have brought the concept of time shifting to television watchers, as users can watch shows they record when their own time permits, rather than being required to watch shows at the time when they are broadcasted. DVR devices are limited to a certain amount of hard drive space, so accordingly, the capacity of DVR devices limits the number of television shows the DVR device can record. Subsequently, DVR users frequently find themselves deleting files (representing episodes) that they have already viewed.

Many times a DVR user might forget they have already watched a certain show or episode. Unfortunately, in the current art, a DVR user must rely on his or her own memory and determine from the limited show titles/summaries in their electronic programming guide (EPG) whether or not they should record a given show or episode. Many times, this summary information is not enough for the user to realize whether they have already seen a particular show. Consequently, when the viewer plays back the recorded episode, they realize they have already seen the show, at which point they have already consumed disk space in the recording process. The user may further spend a certain amount of time watching the already viewed episode before realizing they have already seen it.

Thus, there is a need for an improved system and methodology for enabling a user to generate metrics for, and maintain a record of, watched or partially watched DVR programs.

### SUMMARY OF THE INVENTION

A method and system are provided in which DVR viewer metrics are collected and saved in a “Watched Log” database including identifying titles and other features of recorded DVR programs. User viewing metrics on both “per user” and “per show” basis are saved and used to augment existing conflict resolution techniques by removing shows that have been entirely or partially viewed in favor of shows that have not already been viewed. After a DVR user watches a TV show episode, the TV show episode will be added to the Watched Log. Subsequently, before recording a future TV show, the DVR device can verify that the scheduled TV show episode has not already been watched by the user. If the show is in the Watched Log, various rules are used to determine which recording actions to take.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing a display device and a digital video recorder control unit in which the present invention may be implemented;

FIG. 2 is a schematic block diagram showing several of the major components of a digital video recorder control unit in an exemplary implementation of the present invention;

FIG. 3 is an illustration of an exemplary Program Guide useful in explaining an operation of the present invention;

FIG. 4 is an illustration of an exemplary Recording Log useful in explaining an operation of the present invention;

FIG. 5 is an illustration of a flow chart showing an exemplary operational sequence including the methodology of the present invention;

FIG. 6 is a flow chart illustrating an exemplary operational sequence when a DVR recording conflict is detected;

FIG. 7 is an exemplary flow chart illustrating an updating operation to the Watched Log of the present invention;

FIG. 8 is an illustration of an exemplary Watched Log database; and

FIG. 9 is an illustration showing a network connection of a plurality of viewers using a common Watched Log for recorded programs.

### DETAILED DESCRIPTION

It is noted that devices and functions which are shown in block or schematic form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. The term “network” or “network-connected”, as used herein, may be a hard-wired or wireless network and may include an in-building network, or a wide area or other more expansive network accessed over the Internet for example.

In accordance with one exemplary embodiment of the invention, after a DVR user watches a TV show episode, the TV show episode will be added to a watched log. Subsequently, before recording a future TV show, the DVR device verifies that the scheduled TV show episode is not already in the “Watched Log.” If the show is in the Watched Log, various rules are used to determine which recording actions to take.

The Watched Log stores viewing information as a percentage of the show watched, allowing for more granular tuning and conflict resolution management. The Watched Log also stores the number of times a show has been recorded and viewing information for each of those recordings. Finally, the Watched Log stores the dates and times a show has previously been recorded. In one embodiment, all of the above information is segmented by user identity, to enable the use of the Watched Log by a plurality of viewers in households or other networks with many viewers.

A rules engine augments the existing well known techniques in DVR recording conflict management. The goal of known recording conflict management techniques is to anticipate to the highest degree of accuracy available, the decisions a user would take if that user was engaged in each decision of which show to record when there is an “either-or” decision because of limited recording space. Recording conflict management is necessary because of the limited number of tuners or input channels that can be used to record simultaneous shows. The rules engine will enable more accurate conflict resolution decisions by applying information derived from the Watched Log. The Rules engine uses information about how often a show has been watched, how recently it has been watched, and what percentage of the show has been seen. The combination of these data points will enable more effective conflict management in the recording of DVR programs.

The disclosed methodology operates by keeping a log of shows watched via the DVR device inside a relational store (e.g., a database). When a user completes the watching of a TV show, the user can optionally be presented with an choice to add an entry to a table known as the Watched Log. Typically the creation of such a table entry is accomplished automatically, unless the user chooses to override the default setting. At the time a show is recorded on the DVR, the first entry is logged which consists of a unique identifier for the show. The date and time of the recording and other distinguishing characteristics are also recorded including, but not limited to: (1) User or Users (if applicable); (2) Date/Time of recording; (3) Date/Time viewing began; (4) Date/Time viewing was completed; and (5) Percentage of show viewed. At the time the user begins watching a recorded show, the Watched Log will be updated to reflect the start time. If the user watches the show in its entirety, that too will be reflected in the log. This is indicated with both a percentage complete (100%) and optionally, a “Time-to-complete” which would be equal to (offset by a small threshold which can be user defined) the length of the show. If the playback of the show is paused or indefinitely postponed, then the percentage complete entry is updated accordingly. Although focus of the exemplary embodiment includes only a single user, it is noted that the Watched Log methodology applies also to groups of viewers and is also user-specific so that one user's watched data is separate every other user.

The following factors, inter alia, are derived from the Watched Log data to augment existing recording conflict management techniques. The list is not intended to be comprehensive and other useful data could be derived from the available DVR data and entered into the Watched Log. The factors implemented in the exemplary embodiment include: (1) Delay from Record Time to Watch Time; (2) Percentage of show watched, i.e. played or watched time as a percentage of time required for a complete showing; (3) Number of times the show has been watched previously; (4) Most recent viewing of show; and (5) Time to complete viewing. The above data are all easily derived from the elements recorded in the Watched Log. Once derived, they can be used to determine which of two or more conflicting potential recordings should take precedence. A rules engine is used to implement this. The rules engine requires the preferences of the end user to be entered in manually one time. Once preferences have been established—e.g., which of the recording criteria are most important to the user ranked in priority order, what threshold constitutes recent viewings, etc., then existing conflict management techniques can be augmented in accordance with the Watched Log described herein. For example, it is well known in various DVR solutions that a user can place the recording of one show in priority over any other show, essentially a prioritized list; however, there are no methods available to sort conflicts out for shows that have not been prioritized.

In accordance with the present invention, in future instances when the DVR device will record a show marked for recording (either directly or indirectly through zones), the DVR device will first check to see if an entry exists in the already Watched Log table. As used herein, “recording zones” refers to the selection of only times, days and/or channels for recording rather than specific shows. If an entry exists corresponding to the show about to be recorded, the DVR will first determine if there is unreserved capacity on the drive and if there are any conflicting recordings. If either or both of these conditions exist, then the DVR can use the Watched Log to determine or help determine if the show should be recorded. This recognition of shows about to be recorded can be performed as soon as a discovery is made that an entry exists in the Watched Log that was marked for recording from the electronic program guide or other input to the DVR.

Watched Log Information can be imported or exported for backup purposes or for synchronization with other Watch Logs on other DVRs belonging to a user. In one embodiment, the DVR will associate an already watched show log with multiple users. When deciding to record, the DVR device will confirm that all users registered with the DVR have stated that a given show has been watched. In one example, after watching a show, the viewers of the show are asked to confirm which of the users registered with the DVR were present for the viewing of the show. Upon completion of a show's viewing, the DVR optionally asks whether the show should be broadly marked as viewed, or just viewed by a subset of the viewers in the household. In another implementation, radio frequency identification (RFID) technology may be used whereby RFID tags are worn by viewers and their presence in the vicinity of a DVR is detected while a show is being watched. The watched log is automatically updated when a viewer leaves the detectable vicinity of the DVR device or when a show is completed.

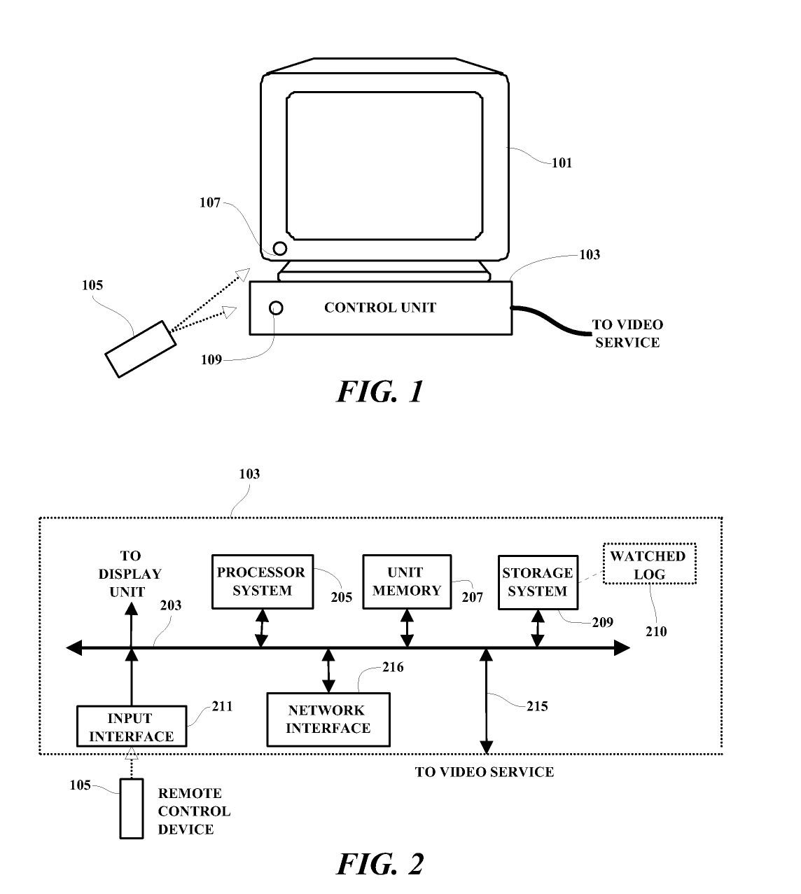

As shown in FIG. 1, an exemplary embodiment of the present invention includes a display device 101 which is connected to a digital video recorder (DVR) control unit 103. A remote control unit 105 enables a user to input commands and/or menu selections through sensing receptors 107 and 109 on the display 101 and the control unit 103, respectively. The control unit 103 is arranged for connection to a video service which provides programs for viewing on the display unit 101.

As shown in FIG. 2, the control unit 103 includes, inter alia, a main bus 203 connected to the display unit 101. Also connected to the main bus 203 are a processor system 205, a unit memory 207, a storage system 209 which includes the Watched Log database 210, the input interface 211 which is arranged for receiving signals from the user remote control device 105, and a network interface 216 which is arranged for selective connection to an interconnection network. A connection 215 is also provided for the video service input.

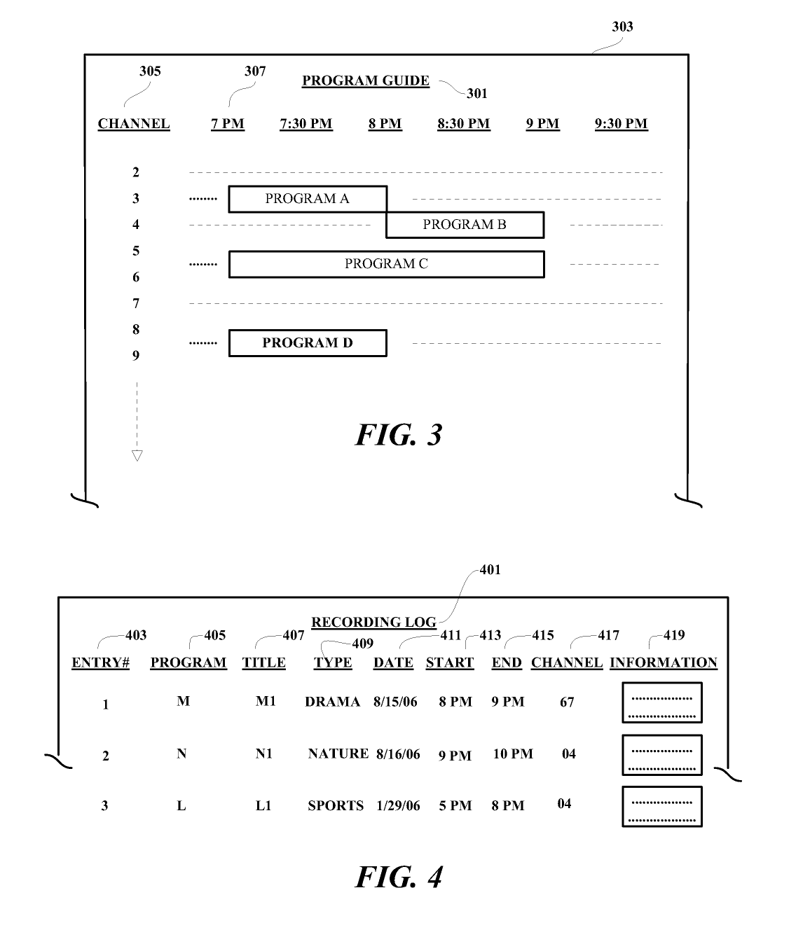

FIG. 3 illustrates an exemplary Program Guide 301 which is selectively displayed to a user on a display screen 303 of a monitor or display device 101. The Program Guide 301 includes, in a first column 305, the various channels which may be selected by the user. Also shown are various time slots 307 during which various programs are scheduled to be presented. The user is enabled to control the selection of certain ones of the programs through the use of the remote control device 105. In an exemplary operation, it is presumed that Programs A, B and C have already been scheduled to be recorded, and the user wishes to schedule an additional program, i.e. Program D from the user's control unit. The user will highlight Program D on the Program Guide and push a “Record” button (not shown) on the remote control unit 105.

FIG. 4 illustrates an example of a Recording Log 401 which includes database entries corresponding to programs which have been recorded by one or more users on a common DVR system. The Recording Log 401 identifies an entry number 403, a program or series name 405, a program title 407, a type 409 or classification for the designated program, a date 411 on which the program was recorded, a start time 413 and an end time 415 for the recorded program, a channel identity 417 for the channel the program was recorded from and an information entry 419 which indicates that additional information is available concerning a highlighted program. A user is enabled to highlight the program of interest and actuate an “Information” button on the remote control unit 105 to generate an overlying information window on the user display. For example, the information entry window (not shown) will include a description of the corresponding program as well as other information such as actors if the program is a drama or movie and date that the movie was created. For sports programs, the information field will include, for example, the type of sports i.e. baseball, football, tennis, etc., and also the names of the teams and the date that the sports event took place. Also, inter alia, the information window will contain the names of key players etc. All of the information in the Recording Log 401, including the information in the information window, is program-accessible and also searchable by a user, and may be accessed by various user programs for one or more users to search for specific user-preferred items.

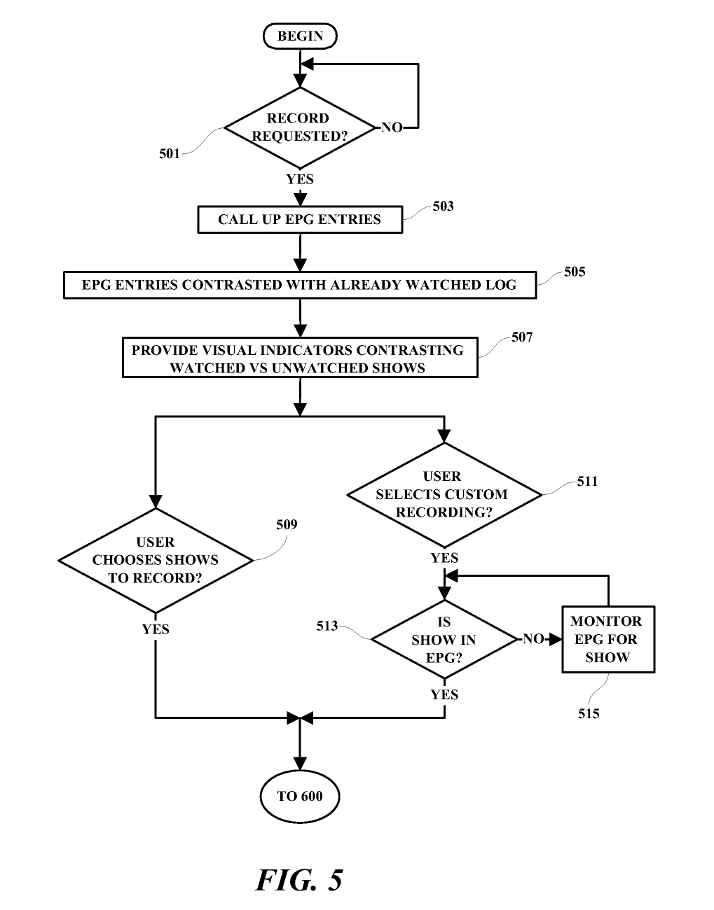

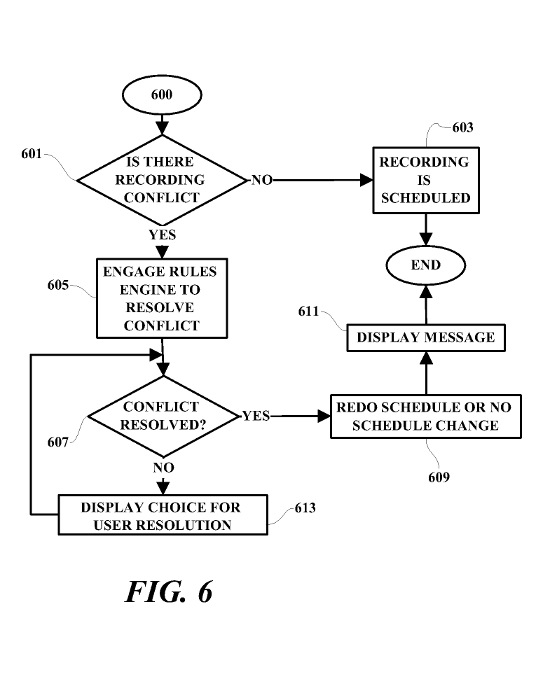

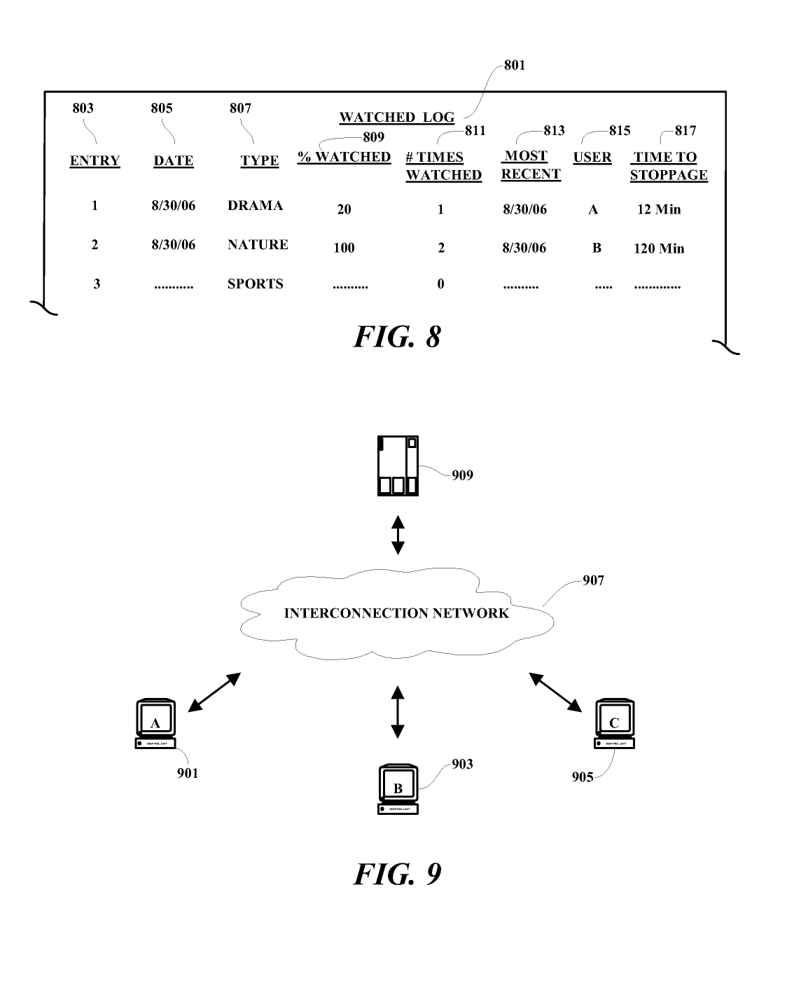

As shown in FIG. 5, when a user requests a recording 501, the EPG entry log 301 is called up 503 and, in accordance with the present invention, the EPG entries are contrasted with a Watched Log (FIG. 8) 505 and visual indicators are generated 507 on the user's display to indicate which shows have already been watched. For example, shows on the EPG may be displayed in a different color or a separate column may be added to indicate that a particular show has already been recorded or watched by the user. If the user then selects a custom recording feature 511, a determination is made if the show which the user wishes to record 511 is in the EPG 513. If not, the processing will periodically monitor 515 future changes in the EPG to determine when the selected show is scheduled to be shown. The custom recording feature enables a user to input to an input screen (not shown) various characteristics of a show which the user wishes to have recorded. For example, the user may be prompted to input any of the data contained in the Recording Log 401 (such as program name, title, actors, etc.) and the program will monitor the EPG for a future match. When the input show appears in the EPG 513, or if the user selects to record a show already present on the EPG 509, then the processing continues as shown in FIG. 6.

After a show is selected for recording 600, it is determined whether or not there is a recording conflict 601. If there is no recording conflict 601, the recording is scheduled 603 and the process ends. If it is determined that a recording conflict exists 601, then a Rules Engine is engaged 605 to resolve the conflict. A conflict would exist, for example, if the user selected to record a show for a time slot for which the user's allowed number of shows had already been scheduled to be recorded. The conflict Rules Engine would then access a user preference file and, depending upon the outcome of the conflict resolution 607, the process would continue by either canceling the recording of a show already scheduled to be recorded to make storage space available for the newly selected show, or make no changes to the recording log 609. A message is then displayed 611 to the user advising the user of what action has been taken, i.e. either which show has been cancelled or that no re-scheduling has occurred. Optionally, when there is a conflict which cannot be resolved 607, the conflict information is presented to the user 613 for resolution by user input.

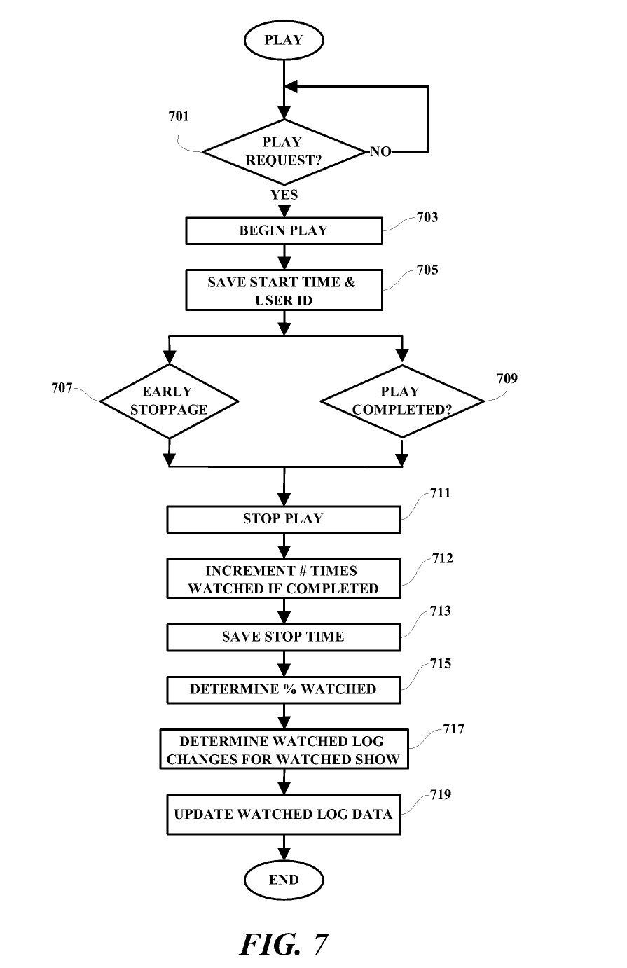

In FIG. 7, a exemplary flow chart is presented to illustrate a typical operation of the methodology disclosed herein. As shown, when a user makes a play request 701 to play a recorded show, the selected show begins to play 703 on the user's display 101. The start time of the playing of the selected show is recorded together with the ID of the user requesting the play 705. The user ID is input by the user at the time the request to play is made. This may be accomplished by a selection from a menu of users authorized to operate the particular DVR device. Thereafter, if the show plays to completion 707 or if there is an early stoppage of the playing 709 by the user, the playing of the selected show is stopped 711. If the show had been completed 709, the system increments the “# of times watched” field 712 in a “Watched Log” database (FIG. 8). The stop time is also saved 713 and the percentage of show watched before stoppage is determined 715. Other data relating to the selected “watched show” are also determined 717 and all of the changes resulting from the user's most recent viewing of the selected recorded show are gathered and input to update the Watched Log database 719. In this manner, new statistical data regarding the Recording Log and the user's viewing habits, are created. These data include, but are not limited to: (1) Which of the recorded shows have been watched; (2) How much of the played recorded show has been watched; (3) Which users watched which shows; (4) Which shows were only partially watched; (5) What percentage of a plurality of authorized viewers watched which shows in their entirety; etc. Once the users' viewing actions are known with respect to particular shows, this information can be used in many ways to improve the efficiency of the recording and viewing processes for one or many authorized DVD users.

FIG. 8 illustrates several of the data points which are tracked in an exemplary “Watched Log”. As shown, each line entry has an entry number 803 for correlation purposes to other data files such as the Recording Log 301. The program names and titles of the shows may also be included. The date that a show is partially or wholly watched is also recorded 805. The type of show 807 and the percent watched 809 information is also tracked along with the number of times watched 811, the most recent playing 813, the particular user 815 who watched the show and the time from start to stop of the particular line item show. For example, show #1 was watched on Aug. 30, 2006 by user “A”, but only 20% or 12 minutes of the show was watched before stoppage. Further, user “B” watched show #2 until completion twice on Aug. 30, 2006.

The Watched Log system disclosed herein may be implemented for only one user or for many users or DVR stations. As shown in FIG. 8, DVR stations or users A, B and C are connected through an interconnection network 907, such as the Internet, to a video source or video server 909. The Watched Log database may be created and stored in each of the individual storage devices within the stations A, B, and C, or in the video server storage, to track the viewing habits or viewing events of each authorized user having access to the individual DVR devices.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for providing a viewing history of a user for video programs accessible by said user, said method comprising:
maintaining a user log of recorded video programs which have been at least partially watched by said user;
displaying a program listing of video programs available for recording by said user; and
providing a perceptible indicium to said user, said perceptible indicium being indicative of which of said video programs in said program listing is already included in said user log of watched video programs.

2. The method as set forth in claim 1 wherein said perceptible indicium is a visual indicium presented on said program listing.

3. The method as set forth in claim 1 wherein said user log includes data related to an amount of play time during which at least one of said recorded video programs has been at least partially played by said user.

4. The method as set forth in claim 1 wherein a plurality of users have access to said program listing, said method further including providing a user log for each of said plurality of said users whereby each user log includes a listing of video programs which have been at least partially watched by each of said plurality of users, respectively.

5. The method as set forth in claim 3 wherein a plurality of users have access to said program listing, said method further including providing a user log for each of said plurality of said users whereby each user log includes a listing of video programs which have been at least partially watched by each of said plurality of users, respectively.

6. The method as set forth in claim 1 wherein said user log includes data indicative of what percentage of each of said watched video programs has been watched by said user.

7. The method as set forth in claim 6 and further including saving a run time indicative of a time period needed to play a recorded video program in its entirety, said method further including saving start and stop times when said user starts and stops a playing of one of said recorded video programs, said start and stop times being used in determining said percentage.

8. The method as set forth in claim 1 wherein said user log includes data indicative of dates on which each of said watched video programs has been watched by said user.

9. The method as set forth in claim 1 wherein said user log includes data indicative of times at which each of said watched video programs has been watched by said user.

10. The method as set forth in claim 1 wherein said user log includes data indicative of types of programs for each of said watched video programs.

11. The method as set forth in claim 1 wherein said user log includes data indicative of a most recent viewing of each of said watched video programs.

12. A programmed storage medium, said programmed storage medium being selectively coupled to processing circuitry, said programmed storage medium containing indicia readable by said processing circuitry for providing program signals effective for providing a viewing history of a user for video programs accessible by said user, said program signals being effective for enabling:
a creating of a user log of recorded video programs which have been at least partially watched by said user;
a displaying of a program listing of video programs available for recording by said user; and
providing a perceptible indicium to said user, said perceptible indicium being indicative of which of said video programs in said program listing is already included in said user log of watched video programs.

13. The medium as set forth in claim 12 wherein said perceptible indicium is a visual indicium presented on said program listing.

14. The medium as set forth in claim 12 wherein said user log includes data related to an amount of play time during which at least one of said recorded video programs has been at least partially played by said user.

15. The medium as set forth in claim 12 wherein a plurality of users have access to said program listing, said program signals being further effective for providing a user log for each of said plurality of said users whereby each user log includes a listing of video programs which have been at least partially watched by each of said plurality of users, respectively.

16. The medium as set forth in claim 14 wherein a plurality of users have access to said program listing, said program signals being further effective for providing a user log for each of said plurality of said users whereby each user log includes a listing of video programs which have been at least partially watched by each of said plurality of users, respectively.

17. A system for providing a viewing history of a user for video programs accessible by said user, said system comprising:
a system bus;
a CPU device connected to said system bus;
a user display device connected to said system bus; and
storage means arranged for storing a user log of recorded video programs which have been at least partially watched by said user, said system being operable for displaying a program listing of video programs available for recording by said user, said system being further operable for providing a perceptible indicium to said user, said perceptible indicium being indicative of which of said video programs in said program listing is already included in said user log of watched video programs.

18. The system as set forth in claim 17 wherein said user log includes data related to an amount of play time during which at least one of said recorded video programs has been at least partially played by said user on said user display device.

19. The system as set forth in claim 17 wherein a plurality of users have access to said program listing, said system being further effective for providing a user log for each of said plurality of said users whereby each user log includes a listing of video programs which have been at least partially watched by each of said plurality of users, respectively.

20. The system as set forth in claim 18 wherein a plurality of users have access to said program listing, said program signals being further effective for providing a user log for each of said plurality of said users whereby each user log includes a listing of video programs which have been at least partially watched by each of said plurality of users, respectively.
